(19) United States
(12) Patent Application Publication
(10) Pub. No.: US 2020/0045042 A1
(43) Pub. Date: Feb. 6, 2020

(54) PHYSICAL ACTIVITY ASSESSMENT SYSTEM

(71) Applicant: For Long Life Corp, Bridgewater, NJ (US)

(72) Inventor: Shiquan Peng, Bridgewater, NJ (US)

(21) Appl. No.: 16/141,144

(22) Filed: Sep. 25, 2018

Related U.S. Application Data
(60) Provisional application No. 62/714,669, filed on Aug. 4, 2018.

(51) Int. Cl. H04L 29/06; G06F 1/16; A63B 24/00; H04L 9/06; G06F 17/30; G01S 19/39; H04W 4/029; H04W 4/38

(52) U.S. Cl. CPC H04L 63/0861; G06F 1/163; A63B 24/0059; H04L 9/0643; A63B 2024/0068; G01S 19/39; H04W 4/029; H04W 4/38; H04L 2209/38; G06F 17/30185

(57) ABSTRACT

Aspects of a physical activity assessment system are described herein. As an example, the aspects may include authenticating physical activity data based on biometric data collected from a user. The aspects may further include accumulating the authenticated physical activity data and generating a block based on a determination that the accumulated authenticated physical activity data reaches a predetermined threshold. Further still, the aspects may include calculating a reward token that corresponds to the block based on a reward pool database.

### BACKGROUND

It has been scientifically shown that sufficient physical activities can improve life expectancy and qualify of life. However, according to a report by National Institute of Health, “28.0% of Americans, or 80.2 million people, ages six and up are physically inactive; less than 5% of adults participate in 30 minutes of physical activity each day; only one in three adults receive the recommended amount of physical activity each week; only one in three children are physically active every day; more than 80% of adults do not meet the guidelines for both aerobic and muscle-strengthening activities, and more than 80% of adolescents do not perform enough aerobic physical activity to meet the guidelines for youth.”

As a result, health/life insurance companies engage and reward the customers to incentivize the customers to participate in more physical activities. It is found that correlation exists between a well-crafted incentive program and lowering healthcare costs. Further, wearable devices are developed to record the physical activities and designed to encourage people to participate in more physical activities.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure describes examples of a physical activity assessment system with rewards. An example user device in the physical activity assessment system may include a transceiver configured to receive physical activity data and biometric data from a first wireless wearable device. The physical activity data may be authenticated based on biometric data collected from a user. Further, the example user device may include an activity tracking processor configured to accumulate the received physical activity data. Further still, the example user device may include a block generator configured to determine that the accumulated physical activity data reaches a predetermined threshold, and generate a block based on the determination that the accumulated physical activity data reaches the predetermined threshold.

An example physical activity assessment system may include a first wireless wearable device configured to transmit physical activity data authenticated based on biometric data collected from a user. Further, the example physical activity assessment system may include a user device configured to receive the authenticated physical activity data, accumulate the authenticated physical activity data, and generate a block based on a determination that the accumulated authenticated physical activity data reaches a predetermined threshold. Further still, the example physical activity assessment system may include a first blockchain network node configured to receive the block from the user device, add the received block to a reward pool database, and calculate a reward token based on the reward pool database.

An example method for assessing physical activities may include authenticating physical activity data based on biometric data collected from a user; accumulating the authenticated physical activity data; generating a block based on a determination that the accumulated authenticated physical activity data reaches a predetermined threshold; and calculating a reward token that corresponds to the block based on a reward pool database.

To the accomplishment of the foregoing and related ends, the one or more aspects comprise the features herein after fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating one or more example physical activity assessment systems connected to a blockchain network in which blockchain technology may be implemented;

FIG. 2 is a block diagram illustrating example devices of the physical activity assessment system in which blockchain technology may be implemented;

FIG. 3 is a flow chart of aspects of an example method for authenticating the physical activity in the example physical activity assessment system; and

FIG. 4 is a flow chart of aspects of an example method for assessing physical activity in which blockchain technology may be implemented.

### DETAILED DESCRIPTION

Various aspects are now described with reference to the drawings. In the following description, for purpose of explanation, numerous specific details are set forth in order to provide a thorough understanding of one or more aspects. It may be evident, however, that such aspect(s) may be practiced without these specific details.

As described in greater detail below, aspects of a physical activity assessment system may include a wireless wearable device (e.g., a fitness tracker) configured to collect biometric data and physical activity data via sensors integrated in the wireless wearable device. The physical activity data, if authenticated by the wireless wearable device, may be uploaded to a user device (e.g., a smart phone, a laptop, a computer). If the authenticated physical activity data is accumulated to a predetermined level, the user device may be configured to generate a block and submit the block to a blockchain network node in a blockchain network. The blockchain network node, similar to other nodes in the blockchain network, may be configured to maintain a reward pool database. According to a smart contract between the user device and the blockchain network node, the blockchain network node may be configured to allocate a reward token to the user device and update the reward pool database accordingly.

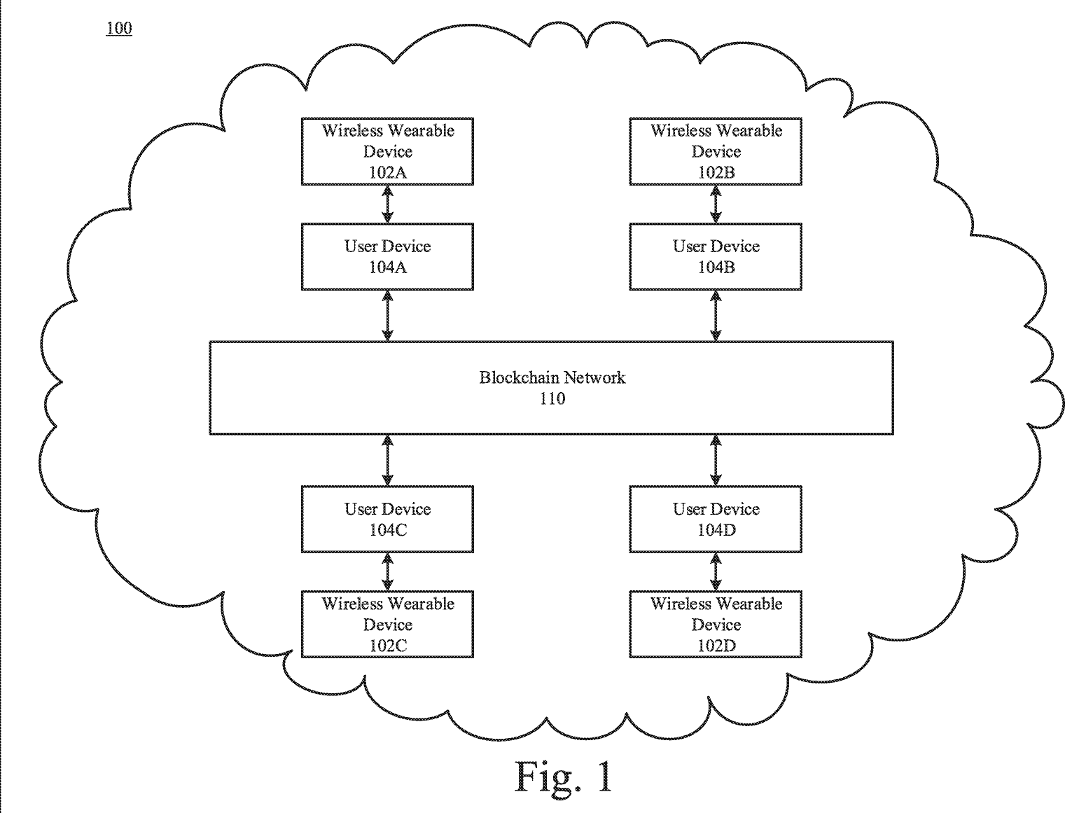

FIG. 1 is a block diagram illustrating one or more physical activity assessment systems connected to a blockchain network in which blockchain technology may be implemented. As depicted, a network configuration 100 may be represented as a network cloud that may be an enterprise network, the Internet, a private network, etc. The blockchain network 110 may include one or more network nodes that may be different types of computing devices operating on and communicating over the blockchain network 110. The number of the network nodes may depend on the size of the blockchain network 110. In some examples, the blockchain network 110 may be connected to user devices 104A, 104B, 104C, and 104D (collectively referred to as user devices 104) that may be configured to communicate with other network nodes over the blockchain network 110. The user devices 104A, 104B, 104C, and 104D, in these examples, may also be considered as network nodes of blockchain network 110.

Wireless wearable devices 102A, 102B, 102C, and 102D (collectively referred to as wireless wearable devices 102) may be respectively connected to the user devices 104A, 104B, 104C, and 104D via one or more wireless communication protocols, such as Bluetooth, Wi-Fi, etc. Each of wireless wearable devices 102 may be assigned with a unique identification. In some examples, wireless wearable devices 102 may be include multiple sensors configured to collect biometric data and physical activity data of a user to which a respective wireless wearable device is attached. The biometric data may include blood pressure, heart beat rate/pulse, body temperature, etc. The physical activity data may include running steps, running distance, and the corresponding time stamps. In some examples, the multiple sensors may include an accelerometer configured to measure acceleration of the wireless wearable device and a gyroscope configured to measure the orientation based on the direction of the gravity. The acceleration and the measured orientation may be further processed together to determine the user's movement including running steps, traveled distance, etc. Further the multiple sensor may include a heart rate sensor or a heart beat sensor configured to measure the heart rate or heart beat count of the user and an electrocardiogram (ECG or EKG) sensor configured to measure cardiac electrical potential waveforms (i.e., voltages produced during the contraction of the heart). In addition, each of the wireless wearable devices 102 may include an electronic timepiece configure to measure time and associate timestamps with the measured physical activity data.

Taking the wireless wearable device 102A and the user device 104A as an example, the physical activity data, once authenticated, may be transmitted to the user device 104A. The user device 104A may be configured to store the physical activity data in a physical activity database and accumulate the physical activity data. When the physical activity data is accumulated to exceed a predetermined threshold, the user device 104A may generate a block and submit the block to the blockchain network 110. In at least some examples, the block may include the authenticated physical activity data and may be permanently stored in the blockchain network 110.

For example, the user device 104A may determine that the accumulated running distance exceeds 5 miles. Based on such determination, the user device 104A may be configured to generate a block that includes the physical activity data pertaining to the 5 miles distance such as the time stamps of each period of running, the running distances of each period of running, the heart beat rate corresponding to each period of running, etc.

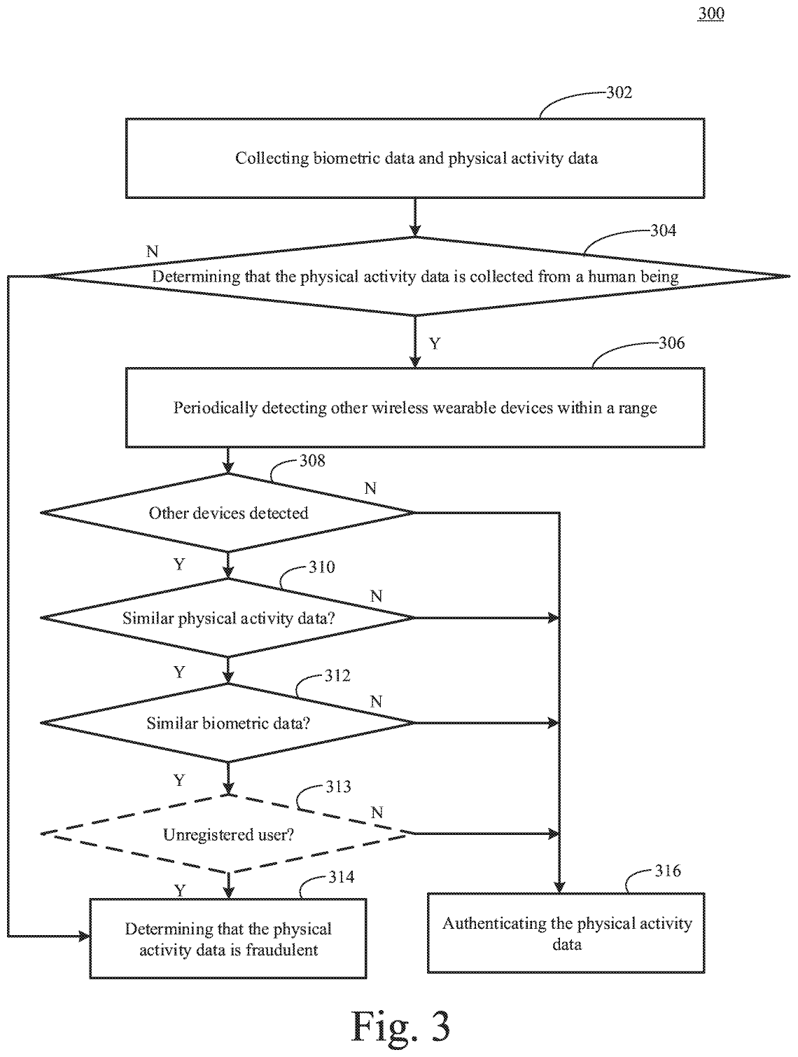

A process for authenticating the physical activity data is described in more detail in accordance with FIG. 3.

Upon receiving the block, at least a node of the blockchain may be configured to add the received block to a reward pool database. Based on a smart contract, the node may be configured to assign a reward token to the user device 104A and update the reward pool database accordingly.

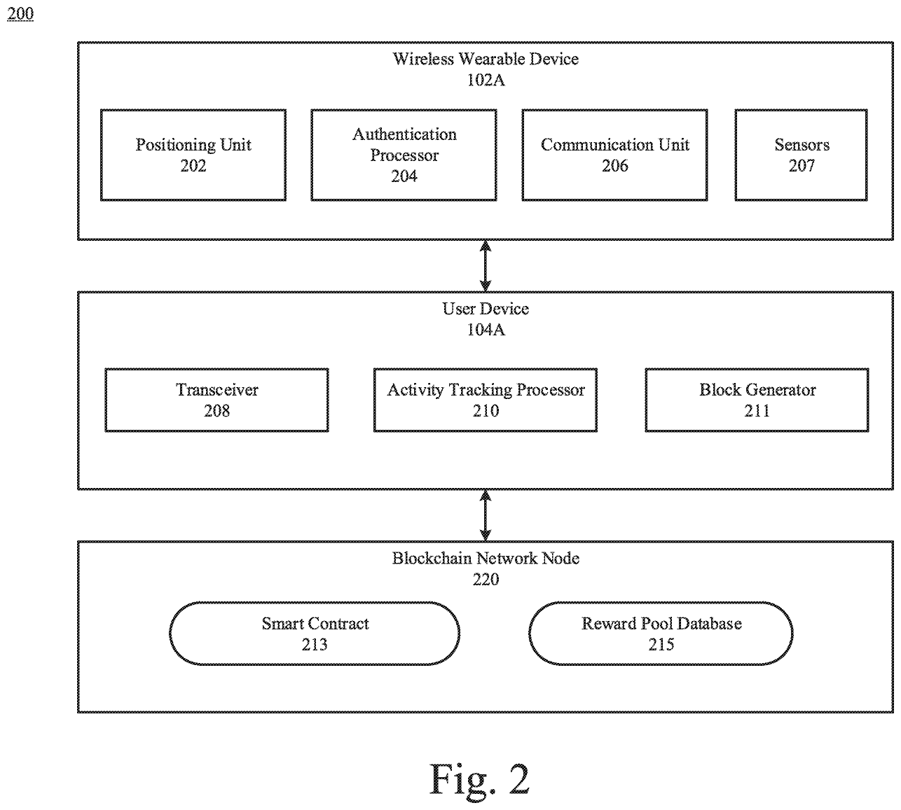

FIG. 2 is a block diagram illustrating example devices of the physical activity assessment system in which blockchain technology may be implemented. As depicted, the wireless wearable device 102A may be wirelessly connected to the user device 104A. The wireless wearable device 102A may include a positioning unit 202 configured to measure global positioning information of the wireless wearable device 102A. Further, as described above, the wireless wearable device 102A may include one or more sensors 207 configured to collect the biometric data and the physical activity data. The sensors 207 may include a thermometer, an accelerometer, a gyroscope, a heart rate sensor, and an electrocardiogram (ECG or EKG) sensor. The wireless wearable device 102A, the user device 104A, the blockchain network node 220, and the components therein may be implemented as hardware, firmware, or software components, or any combination thereof.

Further, the wireless wearable device 102A may include an authentication processor 204 configured to authenticate the collected physical activity data. In more detail, when the biometric data and the physical activity data are collected, the authentication processor 204 may be configured to first determine whether the wireless wearable device 102A is attached to a human being or other non-human animals or another human being different from the registered user based on the biometric data. For example, when the detected body temperature is substantially lower than human body temperature for a preset period, the authentication processor 204 may be configured to determine that the wireless wearable device 102A is not attached to a human being. In another example, when the detected heart beat rate is substantially higher than human heart rate (e.g., cat's heart rate is between 140 and 200 beats per minute), the authentication processor 204 may be configured to determine that the wireless wearable device 102A is not attached to a human being. If it is determined that the wireless wearable device 102A is not attached to a human being, the collected biometric data and the physical activity data may be marked as false data. In some examples, the authentication processor 204 may be configured to disable the wireless wearable device 102A for a predetermined period to discourage generating false data by attaching the wireless wearable device 102A to a non-human animal.

If the authentication processor 204 determines that the wireless wearable device 102A is attached to a human being, the authentication processor 204 may be configured to continue to determine whether there are more than one wireless wearable devices within a predetermined range, e.g., 1.8 meter. If no other wireless wearable devices are found, the physical activity data may be authenticated by the authentication processor 204. If one or more other wireless wearable devices are found within the predetermined range, a communication unit 206 may be configured to exchange the biometric data and the physical activity data with the one or more other wireless wearable device.

For example, the authentication processor 204 may be configured to compare the physical activity data received from other devices and the physical activity data collected from local sensors. In an example where the authentication processor 204 is configured to compare the running speeds respectively collected from the wireless wearable device 102A and other devices, if the running speeds are determined to be substantially different, the authentication processor 204 may be configured to determine that the physical activity data are collected from different wireless wearable devices of different users and authenticate the collected physical activity data.

Further, if the running speeds are determined to be close, e.g., within 0.1 mile per hour, the authentication processor 204 may be configured to compare the biometric data received from other devices and the biometric data collected from local sensors. If the biometric data are substantially different, e.g., the heart rates being 100 beats per minute (bpm) and 54 bpm, the authentication processor 204 may be configured to determine that the physical activity data are collected from different wireless wearable devices of different users and authenticate the collected physical activity data. To the contrary, if the biometric data are substantially similar, e.g., heart rate being 100 bpm and 102 bpm, the authentication processor 204 may be configured to mark the physical activity data as false data. The false data may be deleted by the authentication processor 204 according to at least some examples. In some other examples, the authentication processor 204 may be configured to disable the wireless wearable device 102A and/or other wireless wearable devices that transmitted the similar biometric data for a predetermined period (e.g., 5 minutes, 3 days, etc.) to discourage generating false data. For instance, the authentication processor 204 may send a control bit via the communication unit 206 to the wireless wearable devices that transmitted the similar biometric data to disable the wireless wearable devices.

In some other examples, the authentication processor 204 may be further configured to determine whether the physical activity data is collected from a registered user. For example, when a user registers with the physical activity assessment system (e.g., by submitting a registration quest with a registration option), the wireless wearable device 102A may start to collect the biometric data since the time of the registration. During the authentication process, the authentication processor 204 may be configured to compare the collected biometric data with previously collected and stored biometric data to determine the collected biometric data is from the registered user. For example, when the sensors 207 detect that the resting heart beat rate of the current user is 87 bpm but the stored resting heart beat rate of the registered user is 54 bpm, the authentication processor 204 may determine that the physical activity data is false data if the resting heart beat rate did not decline gradually in the past two months.

Once the physical activity data is authenticated, the communication unit 206 may be configured to transmit the authenticated physical activity data to the user device 104A. In some example, the communication unit 206 may include an antenna, a transceiver, or other components in compliance with the wireless communication protocols, e.g., Bluetooth and Wi-Fi. A transceiver of the user device 104A may be configured to receive the authenticated physical activity data. The authenticated physical activity data may be further transmitted to an activity tracking processor 210. The activity tracking processor 210 may be configured to accumulate the received physical activity data in a physical activity database with the timestamps associated with the received physical activity data.

A block generator 211 of the user device 104A may be configured to determine that the accumulated physical activity data reaches a predetermined threshold. For example, the accumulated running distance may exceed a distance threshold, e.g., 5 miles. The block generator 211 may be configured to generate a block based on the determination. The block may include the physical activity data and the corresponding timestamps. The transceiver 208 may be configured to transmit the generated block to a blockchain network node 220. In some other example, the predetermined threshold may refer to a target duration of moderate intensity physical activity. For example, when the accumulated physical activity data indicates that the user has engaged 6 hours of moderate-intensity physical activity, the block generator 211 may be configured to generate a block. As an example, the time of moderate intensity physical activity (PA) may be calculated in accordance with the following equation:

$$Time ( minutes ) of moderate intensity P A = \frac{\begin{matrix}Total Heart Beat Number - ( nonsleep time - idle time ) \times \\ HBR at rest - sleep time \times HBR at sleep\end{matrix}}{( 220 - Age ) \times Y \% - HBR at rest}$$

in which Y may refer to a value from 65-80, a scientifically calculated threshold for determining whether the activity performed fits into the criteria of being of moderate intensity, (220−Age)×Y % represents the HBR with moderate-intensity physical activity. In a non-limiting example, the time of moderate intensity may be calculated based on four modes of a human body, i.e., sleep mode, rest mode, idle mode and exercise mode. Any activity beyond rest mode can be considered as exercise mode, albeit having different intensity levels. For the same level of PA intensity, the younger participants may be required to show faster HBRs than the older participants. People who exercise regularly and lead active lifestyles have much lower HBRs at rest than people who lead less active lifestyles.

More specifically, assuming a normal person's total daily heart beat numbers are about 24×60 mins×72 bpm=103,680 beats. The maximum heart beat rate may be calculated as (220−age), for example for a 37-year-old person the maximum heart beat rate should be 183 bpm. It is considered as moderate-intensity physical activity when a user reaches 65-80% of maximum HBR, for example for a 37-year-old person the heart beat rate should be 118-146 bpm for the physical activity to be considered as moderate intensity, e.g., 132 bpm. When the collected biometric data indicates that the user's total heart beats are 110,000 beats for the last 24 hours, the beats difference of 110,000-103,680=6,320 beats were contributed by the physical activity. The moderate-intensity physical activity time may be calculated as 6,320/(132−72)=105 minutes.

The blockchain network node 220 may refer to a node of the blockchain network 110. In some examples, the blockchain network node 220 may refer to one of the user devices (e.g., 104B, 104C, or 104D) or other computing devices not shown in FIG. 1. Further to the examples, the blockchain network node 220 may be configured to store a smart contract 213. The smart contract 213 may refer to a file that mandates a correspondence relationship between a block and a reward token. The blockchain network node 220 may be configured to further store or maintain a reward pool database 215. The reward pool database 215 may refer to a database that includes information of one or more blocks and a number of tokens.

In some examples, a monetary value for each block may be predetermined, by a system administrator, based on statistics such as life expectancy difference in different groups of people that engage different levels of physical activity intensity. For example, scientific data may show that the life expectancy is 3.4 years longer for people who have moderate-intensity physical activities for 300 minutes per week for their age from 18 to 70 (52 years total). The value of a year of quality life may be determined to be 202,258 in year 2018 and increases about 4.6% annually considering the inflation factor. The total value created for 52 years of moderate-intensity physical activities may be determined by 3.4×202,258=687,679. Thus, on average, a participating user may create 2,704 blocks from age 18 to 70 and the monetary value per block may be determined to be 254/block for year 2018 and increases by 4.6% every year. The determined monetary value for each block may be pre-stored in the blockchain network node 220 and may be adjusted automatically every year by a determined rate (e.g., 4.6%) or manually by the system administrator.

In some other examples, the monetary value for each block may be adjusted based on a registration value that indicates a choice made by the user to disclose different amount of its personal information in the block. For example, the user device 104A may store the registration value that may indicate that the user chooses to disclose personal information and physical activity data; the user chooses to only disclose anonymous physical activity data; or disclose no information. The monetary value for each block may be higher for those users who choose to disclose personal information and physical activity data than the users who choose to disclose no information.

According to the smart contract 213, the blockchain network node 220 may be configured to calculate the reward token. For example, when the block is generated and transmitted to the blockchain network node 220, the blockchain network node 220 may be configured to update the reward pool database 215 to include the received block. A total value of the blocks in the reward pool database 215 may be calculated by multiplying the number of blocks with the predetermined monetary value per block. According to the smart contract 213, the blockchain network node 220 may be configured to calculate a corresponding number of reward tokens for the total value of the blocks in the reward pool database based on a market value per token.

For example, assuming that the reward pool database 215 includes 100 blocks, that the predetermined monetary value per block is 5, and that the market value of each reward token is 1, the blockchain network node 220 may be configured to calculate the total value of the blocks in the reward pool database 215 to be 5500, which equals to 500 reward tokens.

Further, according to the smart contract 213, the blockchain network node 220 may be configured to distribute a percentage of the total reward tokens to the user devices that generated the blocks and then to distribute the rest of the total reward tokens randomly. For example, the blockchain network node 220 may be configured to first distribute 30% of the total reward tokens, i.e., 150 reward tokens, to the user devices that generated the blocks. In other words, 1.5 reward tokens may be distributed to a user device for each generated block. That is, the user device 104A may receive 1.5 reward token for generating the block. The rest of the reward tokens may be distributed randomly.

FIG. 3 is a flow chart of aspects of an example method 300 for authenticating the physical activity in the example physical activity assessment system. The method 300 may be performed by one or more components of the wireless wearable device 102A, more specifically, the positioning unit 202, the authentication processor 204, the communication unit 206, and the sensors 207. Dash-lined blocks may indicated optional operations.

At block 302, the example method 300 may include collecting biometric data and physical activity data. For example, the sensors 207 may be configured to collect the biometric data and the physical activity data. As described in accordance with FIG. 2, the accelerometer of the sensors 207 may be configured to measure the acceleration of the wireless wearable device 102A. The gyroscope of the sensors 207 may be configured to measure the orientation based on the direction of the gravity. The heart rate sensor or heart beat sensor of sensors 207 may be configured to measure the heart rate or every heart beat of the user. The electrocardiogram (ECG or EKG) sensor of sensors 207 may be configured to measure cardiac electrical potential waveforms. The process may continue to decision block 304.

At decision block 304, the example method 300 may include determining that the physical activity data is collected from a human being. That is, the authentication processor 204 may be configured to first determine whether the wireless wearable device 102A is attached to a human being or other non-human animals based or other unregistered user on the biometric data. For example, when the detected body temperature is substantially lower than human body temperature for a preset period, the authentication processor 204 may be configured to determine that the wireless wearable device 102A is not attached to a human being. In another example, when the detected heart beat rate is substantially higher than human heart rate (e.g., cat's heart rate is between 140 and 200 beats per minute), the authentication processor 204 may be configured to determine that the wireless wearable device 102A is not attached to a human being. If the physical activity data is determined to be collected from a non-human animal, the collected physical activity data may be marked as false data or fraudulent; otherwise, the process may continue to block 306.

At block 306, the example method 300 may include periodically detecting other wireless wearable devices within a range. For example, the authentication processor 204 may be configured to continue to determine whether there are more than one wireless wearable devices within a predetermined range, e.g., 1.8 meter, 100 feet, etc. In at least some examples, the communication unit 306 may include one or more radio frequency modules that may be configured to periodically transmit radio signals at a specific frequency that only covers the predetermined range (e.g., 2.71-2.75 MHz) and to respond to such radio signals at the specific frequency.

In some other examples, the communication unit 306 may be configured to periodically transmit radio signals that include the global positioning information and to respond to such radio signals with the global positioning information. Authentication processor 204 may be configured to compare the received global positioning information with the position of the wireless wearable device 102A to determine whether other wireless wearable devices are within the predetermined range.

Upon receiving the radio signals, other wireless wearable devices within the predetermined range, if any, may be configured to respond by transmitting biometric data and physical activity data with their unique identification.

The process may continue to decision block 308.

At decision block 308, the authentication processor 204 may be configured to determine if other devices within the predetermined range are detected. If no other wireless wearable devices are detected within the predetermined range, the authentication processor 204 may be configured to authenticate the physical activity data collected at wireless wearable device 102A. If any wireless wearable devices are detected, the process may continue to decision block 310.

At decision block 310, the authentication processor 204 may be configured to compare the physical activity data collected at wireless wearable device 102A with physical activity data collected from the wireless wearable device within the predetermined range. In an example where the authentication processor 204 is configured to compare the running speeds respectively collected from the wireless wearable device 102A and other devices, if the running speeds are determined to be substantially different, the authentication processor 204 may be configured to determine that the physical activity data are collected from different wireless wearable devices of different users and authenticate the collected physical activity data. If the physical activity data are substantially close, the process may continue to decision block 312.

At decision block 312, the authentication processor 204 may be configured to determine whether the biometric data from the biometric data received from other devices and the biometric data collected from local sensors, e.g., sensors 207. If the biometric data are substantially different, e.g., the heart rates being 100 bpm and 54 bpm, the process may continue to block 316. At block 316, the authentication processor 204 may be configured to determine that the physical activity data are collected from different wireless wearable devices of different users and authenticate the collected physical activity data.

To the contrary, if the biometric data are substantially similar, e.g., heart rate being 100 bpm and 102 bpm, the process may continue to an optional decision block 313.

At decision block 313, the authentication processor 204 may be configured to compare the collected biometric data to previously stored biometric data to determine if the current user of the wireless wearable device 102A is the registered user. If yes, the process may continue to block 316 and the authentication processor 204 may authenticate the physical activity data; if not, the process may continue to block 314.

At block 314, the authentication processor 204 may be configured to mark the physical activity data as false data. The false data may be deleted by the authentication processor 204 according to at least some examples.

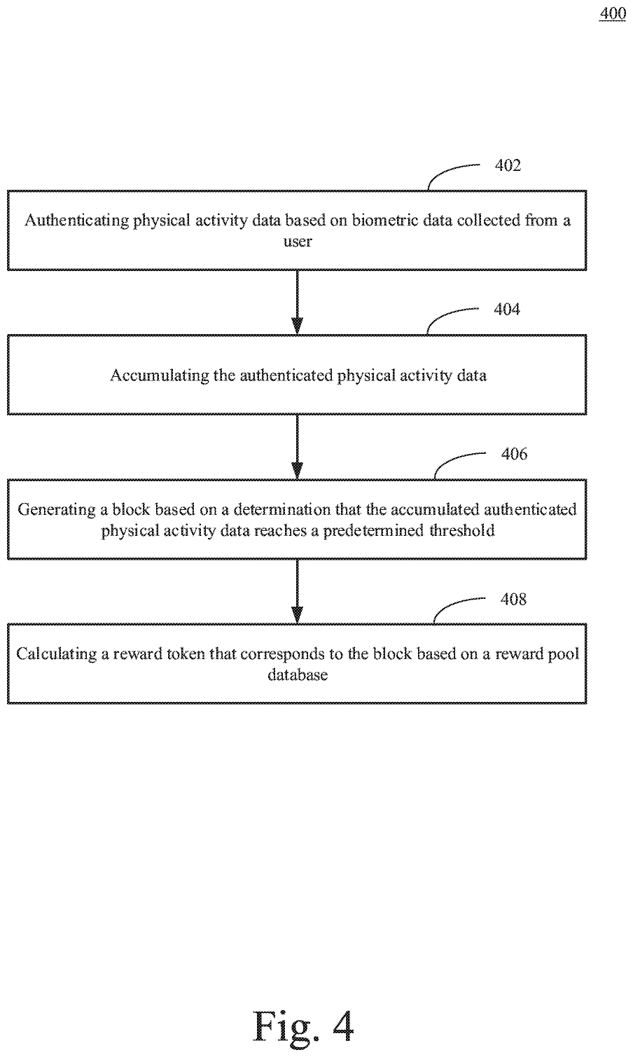

FIG. 4 is a flow chart of aspects of an example method 400 for assessing physical activity in which blockchain technology may be implemented. The method 400 may be performed by one or more components of the wireless wearable device 102A, the user device 104A, and the blockchain network node 220.

At block 402, the example method 400 may include authenticating physical activity data based on biometric data collected from a user. For example, the authentication processor 204 may be configured to authenticate the physical activity data in accordance with FIG. 3. The process may continue to block 404.

At block 404, the example method 400 may include accumulating the authenticated physical activity data. For example, the activity tracking processor 210 may be configured to accumulate the received physical activity data in a physical activity database with the timestamps associated with the received physical activity data. The process may continue to block 406.

At block 406, the example method 400 may include generating a block based on a determination that the accumulated authenticated physical activity data reaches a predetermined threshold. For example, the block generator 211 of the user device 104A may be configured to determine that the accumulated physical activity data reaches a predetermined threshold and further generate a block based on the determination. The process may continue to block 408.

At block 408, the example method 400 may include calculating a reward token that corresponds to the block based on a reward pool database. For example, according to the smart contract 213, the blockchain network node 220 may be configured to calculate the reward token. when the block is generated and transmitted to the blockchain network node 220, the blockchain network node 220 may be configured to update the reward pool database 215 to include the received block. A total value of the blocks in the reward pool database 215 may be calculated by multiplying the number of blocks with the predetermined monetary value per block. According to the smart contract 213, the blockchain network node 220 may be configured to calculate a corresponding number of reward tokens for the total value of the blocks in the reward pool database based on a market value per token.

For example, assuming that the reward pool database 215 includes 100 blocks, that the predetermined monetary value per block is 5, and that the market value of each reward token is 1, the blockchain network node 220 may be configured to calculate the total value of the blocks in the reward pool database 215 to be 5500, which equals to 500 reward tokens.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

1. A user device, comprising:
a transceiver configured to receive physical activity data from a first wireless wearable device, wherein the physical activity data is authenticated based on biometric data collected from a user;
an activity tracking processor configured to accumulate the received physical activity data; and
a block generator configured to:
determine that the accumulated physical activity data reaches a predetermined threshold, and
generate a block based on the determination that the accumulated physical activity data reaches the predetermined threshold.

2. The user device of claim 1, wherein the transceiver is further configured to broadcast the generated block to multiple nodes in a blockchain network.

3. The user device of claim 1, wherein the predetermined threshold is a distance threshold.

4. The user device of claim 1, wherein the predetermined threshold is a time threshold.

5. The user device of claim 1, wherein the physical activity data is authenticated based on a distance between the first wireless wearable device and a second wireless wearable device.

6. The user device of claim 5, wherein the physical activity data is authenticated based on a determination that the biometric data collected from the first wireless wearable device is different from biometric data from the second wireless wearable device.

7. A physical activity assessment system, comprising:
a first wireless wearable device configured to transmit physical activity data authenticated based on biometric data collected from a user;
a user device configured to:
receive the authenticated physical activity data,
accumulate the authenticated physical activity data, and
generate a block based on a determination that the accumulated authenticated physical activity data reaches a predetermined threshold; and
a first blockchain network node configured to:
receive the block from the user device,
add the received block to a reward pool database, and
calculate a reward token based on the reward pool database.

8. The physical activity assessment system of claim 7, wherein the first blockchain network node is further configured to update the reward pool database after adding the received block.

9. The physical activity assessment system of claim 8, wherein the first blockchain network node is further configured to broadcast the updated reward pool database to one or more second blockchain network nodes.

10. The physical activity assessment system of claim 7, wherein the first wireless wearable device includes an authentication processor configured to authenticate the physical activity data based on a distance between the first wireless wearable device and a second wireless wearable device.

11. The physical activity assessment system of claim 10, wherein the authentication processor is configured to authenticate the physical activity data based on a determination that the biometric data collected from the first wireless wearable device is different from biometric data from the second wireless wearable device.

12. The physical activity assessment system of claim 7, wherein the first wireless wearable device includes a communication unit configured to detect a distance between the first wireless wearable device and a second wireless wearable device.

13. The physical activity assessment system of claim 7, wherein the first wireless wearable device includes one or more sensors to collect the biometric data and the physical activity data.

14. The physical activity assessment system of claim 7, wherein the first wireless wearable device includes a positioning unit configured to receive global position information of the first wireless wearable device.

15. The physical activity assessment system of claim 7, wherein the first blockchain network node is further configured to calculate the reward token based on a smart contract file that indicates a correspondence between the received block and the reward token.

16. The physical activity assessment system of claim 7, wherein the user device includes a block generator configured to calculate a time of moderate intensity physical activity based on the authenticated physical activity data and a total count of heart beats in a predetermined period.

17. A method for assessing physical activities, comprising:
authenticating physical activity data based on biometric data collected from a user;
accumulating the authenticated physical activity data;
generating a block based on a determination that the accumulated authenticated physical activity data reaches a predetermined threshold; and
calculating a reward token that corresponds to the block based on a reward pool database.

18. The method of claim 16, further comprising adding the block to the reward pool database and updating the reward pool database.

19. The method of claim 16, further comprising authenticating the physical activity data based on a distance between the first wireless wearable device and a second wireless wearable device.

20. The method of claim 18, further comprising authenticating the physical activity data based on a determination that the biometric data collected from the first wireless wearable device is different from biometric data from the second wireless wearable device.
